(19) United States
(12) Patent Application Publication
(10) Pub. No.: US 2018/0325007 A1
(43) Pub. Date: Nov. 15, 2018

(54) SPRINKLER SHOVEL APPARATUS

(71) Applicant: Shad Tollefsrud, St. George, UT (US)

(72) Inventor: Shad Tollefsrud, St. George, UT (US)

(21) Appl. No.: 15/976,616

(22) Filed: May 10, 2018

Related U.S. Application Data
(60) Provisional application No. 62/504,381, filed on May 10, 2017.

(51) Int. Cl. A01B 1/02; A01G 25/02

(52) U.S. Cl. CPC A01B 1/022; A01G 25/02

(57) ABSTRACT

A sprinkler shovel apparatus has a body having a shovel at a first end and a handle at a second end, the body further having a receptacle for receiving and storing a riser extractor, the riser extractor being coupled to the body and extendable from therein.

### CROSS-REFERENCE TO RELATED APPLICATIONS

This application claims the benefit of U.S. Provisional Application Ser. No. 62/504,381, filed on May 10, 2017, which is incorporated herein by reference

### TECHNICAL FIELD

The present disclosure relates to systems and methods of removing and repairing sprinklers. More particularly, the present disclosure relates to a combination sprinkler shovel and riser extractor.

### BACKGROUND

Lawn and garden care often require the use of sprinklers to ensure adequate moisture is provided. However, it is not uncommon for a sprinkler to fail and require replacing. A majority of sprinklers and their components remain subsurface and are deployed when the sprinkler system is activated and water forced the sprinkler above the surface. As such, in order to effectuate a repair, a user must remove the soil immediately surrounding the sprinkler. A user will often use a standard shovel known in the art to remove the soil. However, standard shovels are not well-suited, as they are large and cumbersome, and require the extraction of much more soil than is needed and often wanted.

Once the soil is removed, the user may then commence work on the sprinkler. One of the problems with standard PVC sprinkling systems is the vulnerability of the sprinkler riser to become lodged in the PVC pipe. Due to this problem, apparatuses exist in the art to effectuate the removal of the riser, which are known as riser extractors or nipple extractors. However, this tool is generally small in size and may become lost quite easily.

As such, there remains a need for an apparatus that can remove appropriate amounts of soil, and that can also extract risers. The present disclosure seeks to solve these and other problems.

### SUMMARY OF EXAMPLE EMBODIMENTS

In one embodiment, a sprinkler shovel apparatus comprises a body having a shovel at a first end and a handle at a second end, the body further comprising a receptacle for receiving and storing a riser extractor, the riser extractor being coupled to the body. In one embodiment, the riser extractor is pivotably coupled to the housing.

### BRIEF DESCRIPTION OF THE DRAWINGS

FIG. 1 is a front elevation view of a sprinkler shovel apparatus with the riser extractor in a stored position within the body;

FIG. 2 is a side elevation view of a sprinkler shovel apparatus with the riser extractor in a stored position within the body;

FIG. 3 is a side elevation view of a sprinkler shovel apparatus with the riser extractor partially extended from within the body; and

FIG. 4 is a is a side elevation view of a sprinkler shovel apparatus with the riser extractor fully extended from within the body.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a system that can remove appropriate amounts of soil, and that can also extract risers. The sprinkler shovel apparatus shown and described herein solves these needs and others by coupling a shovel, shaped complementary to the size of the sprinkler, with a riser extractor.

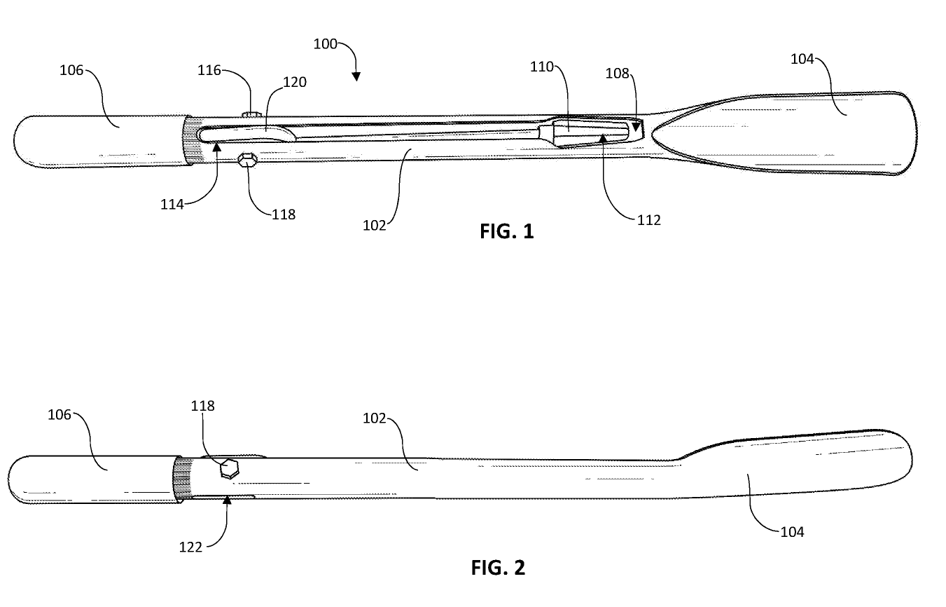

In one embodiment, as shown generally in FIGS. 1-4, a sprinkler shovel apparatus 100 comprises a body 102 having a shovel 104 at a first end and a handle 106 at a second end. The body 102 and shovel 104 may be of single manufacture or an assembly of components. For example, as shown, the single manufactured unit may be accomplished by merely butterflying open the end of the body 102, which is a tube, to form the shovel 104. However, the body 102 and shovel 104 may be separate components, as is frequently done in the art of shovels. When of single manufacture, the tube/column shape of the body 102 imparts significant strength so as to avoid bending or otherwise being compromised during use. Second, because the shovel 104 is of one manufacture, any weak points are significantly reduced. In other words, if the shovel 104 is a separate component that is coupled to a body 102, the connection point is a weak point subject to degradation and compromise faster than a single component structure. Further, any dirt or debris that enters the body 102 is easily removed by falling out of the shovel end. Nonetheless, while the single manufacture is preferred herein, the present invention is not so limited and is meant to include other, multiple component configurations as well. As further appreciated from the Figures, the shovel 104 is optimally shaped so as to complement the shape of a sprinkler. This allows a user to extract an appropriate amount of soil for the job at hand.

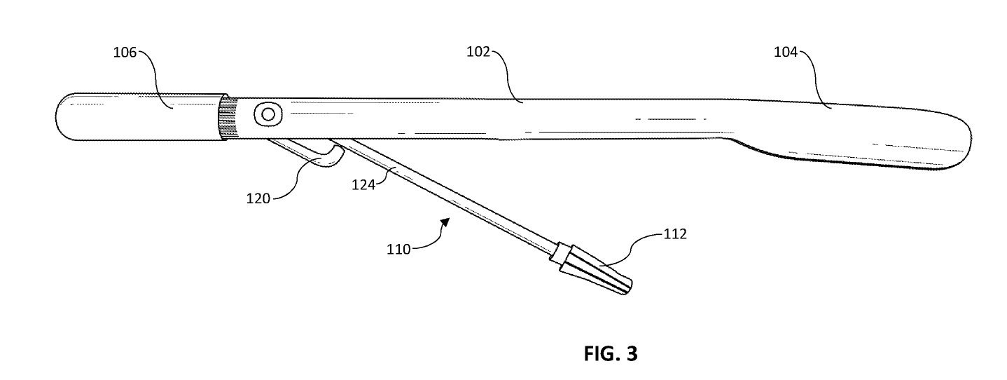

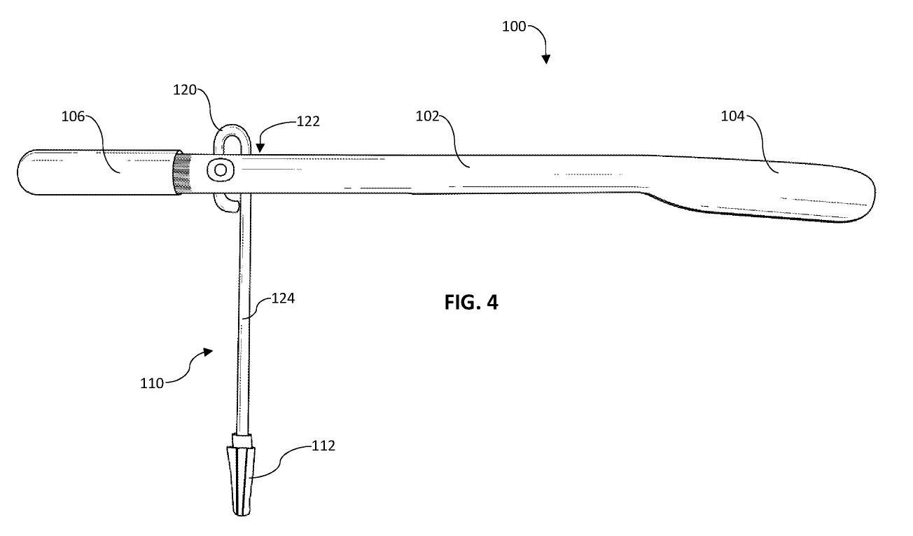

The body 102 further comprises a receptacle 108 for receiving and storing a riser extractor 110. As shown in FIGS. 1-4, the riser extractor 110 is pivotably coupled to the body 102. For example, the body 102 is a tube and has an aperture in the side thereof forming the receptacle 108 within the body 102. The riser extractor 110 comprises a working end 112 and a pivoting end 114. The pivoting end 114 remains coupled to the body 102, such as by using a nut 116 and bolt 118. For example, the bolt 118 transects the body 102 horizontally, with the pivoting end 114 of the riser extractor 110 being coupled to the bolt 118, such as by the pivoting end 114 having a loop 120 (as best seen in FIGS. 3-4). As shown in FIG. 4, the body may have a loop aperture 122 opposite the receptacle 108, allowing the loop 120 to protrude when the riser extractor 110 is pivoted perpendicularly from the body 102. However, such loop aperture 122 is not required. The riser extractor 110 may be secured within the receptacle 108 using a number of securing means, such as twist and lock mechanisms, cotter pins or similar locking pins, bolts, snaps, buckles, or any other number of securing mechanisms known in the art. The riser extractor 110 may comprise a rod portion 124 interposed between the loop 120 and the working end 112. In one embodiment, as shown, the rod 124 is bent to form the loop 120. However, other pivoting means may be used.

In one method of use, a user would grip the sprinkler shovel 100 by the handle 106 and use the shovel 104 to remove the surrounding soil from a sprinkler. Due to the size and shape of the shovel 104 and overall apparatus, soil removal is easily accomplished and lessens the impact on the surrounding area/vegetation. In other words, because the shovel 104 is formed from the body 102, the width of the shovel is equal to the circumference of the body 102. With the circumference approximating the size of a standard PVC pipe used in sprinkling irrigation, the shovel 104 causes very little damage to surrounding vegetation. With the soil removed, the user may then remove the sprinkler. In the event that the sprinkler riser becomes lodged in the PVC, the user may simply extend the riser extractor 110 from within the receptacle 108 and easily remove the lodged riser from the sprinkler. In one embodiment, pivoting of the riser 110 from within the receptacle 108 is as simple as rotating the body 102, which allows gravity to withdraw the riser extractor 110 from within the receptacle 108. Once the work is complete, the user may then rotate the body 102 and pivot the riser extractor 110 back within the receptacle 108. This allows the user to have the tools needed for the job, without having to carry separate tools and without fear of losing the riser extractor. It will be appreciated that while the riser extractor 110 is described as pivoting from within the housing 102, other methods of achieving the same result are contemplated herein. For example, the riser extractor 110 may exit the housing in a variety of manners, whether through pivoting or through longitudinal extension. For example, a channel in the sidewall receives a securing handle from the riser extractor, the extractor extending longitudinally from the handle upon actuation of the securing handle. In one embodiment, the riser extractor is spring-loaded.

It will be appreciated that while various shapes and sizes have been mentioned herein, the present invention is not so limited and the sprinkler shovel apparatus may take many shapes and sizes. In other words, any workable configuration that couples a shovel to a riser extractor is intended to be covered herein.

Therefore, it is appreciated from the foregoing that the sprinkler shovel apparatus described herein solves the need for a shovel that can remove appropriate amounts of soil, and that can also extract risers by coupling a shovel, shaped complementary to the size of the sprinkler, with a riser extractor.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A sprinkler shovel apparatus, comprising:
a body having a shovel at a first end and a handle at a second end;
a receptacle within the body for receiving and storing a riser extractor;
the riser extractor extendable from within the receptacle.

2. The sprinkler shovel apparatus of claim 1, wherein the riser extractor is pivotably coupled to the housing.

3. The sprinkler shovel apparatus of claim 1, wherein the riser extractor comprises a working end, a rod, and a loop.

4. The sprinkler shovel apparatus of claim 1, wherein the shovel is formed from the body by splitting the body open.

5. The sprinkler shovel apparatus of claim 1, wherein the body is a tube and the receptacle is formed from an aperture in the side of the body.

6. A sprinkler shovel apparatus, comprising:
a body formed from a tube;
a shovel at a first end of the body;
a handle at a second end of the body;
an aperture in the sidewall of the body, the aperture forming a receptacle;
a riser extractor comprising a pivoting end and a working end, the pivoting end pivotably coupled to the body; and
wherein the riser extractor is receivable through the aperture and within the receptacle.
